(19) United States
(12) Patent Application Publication
(10) Pub. No.: US 2018/0104713 A1
(43) Pub. Date: Apr. 19, 2018

(54) DEVICE FOR APPLYING FLUIDS

(71) Applicant: EFTEC EUROPE HOLDING AG, Zug (CH)

(72) Inventor: Martin MÜLLER, Friedrichshafen (DE)

(21) Appl. No.: 15/565,923

(22) PCT Filed: Apr. 15, 2016
(86) PCT No.: PCT/EP2016/058426

§ 371 Date: Oct. 12, 2017

(30) Foreign Application Priority Data
Apr. 16, 2015 (EP) 15163897.0

(51) Int. Cl. B05B 13/04; B25J 19/00

(52) U.S. Cl. CPC B05B 13/0431; B05B 15/066; B05B 12/04; B25J 19/0045; B25J 19/0041

(57) ABSTRACT

A device (1) for applying fluids that is suitable for mounting as a tool on a robot arm and method therefor. The device (1) comprises a static element (3), a rotatable element (2) and a coupling point (8), wherein the coupling point (8) connects the static element (3) and the rotatable element (2) in such a way that the rotatability of the rotatable element (2) is effected. The coupling point (8) has, both on the side of the static element (3) and on the side of the rotatable element (2), inductive coupling elements (11, 11′) which are arranged in such a way that inductive energy and/or signal transmission is made possible across the coupling point (8).

The invention relates to a device for applying fluids, to a method for applying fluids, to a method for converting electrical coupling points, and to the use of a coupling point having inductive coupling units, according to the preambles of the independent claims.

Devices for applying fluids may have rotatable components, which, conventionally, are supplied with electric power and controlled via sliding contacts. These sliding contacts in this case enable, for example, a spray head having nozzles to be rotated for the propose of applying the fluid. The rotation capability of the head in this case enables the nozzles to be positioned in dependence on the application specification.

Such a device is known, for example, from EP 1 521 642. The device has a rotating nozzle head, which is supplied with electric power via sliding contacts and connected to a holding part. Channels that go through a rotary bearing and inside the rotating head enable the fluid to be supplied from the holding part to the rotating nozzle head.

However, such devices have the disadvantage that, owing to the structural character of the sliding contacts, the number of transmission channels is limited, and the transmission of sensor and control signals is liable to error. Furthermore, the sliding contacts are liable to become soiled, rapidly become worn and therefore have a high maintenance requirement.

It is therefore an object of the present invention to overcome the disadvantages of the prior art.

In particular, it is an object of the invention to provide a device for applying fluids, in which the electrical energy and signals can be transmitted with precision and by simple means, and without a large space requirement, via coupling points. Moreover, it is intended to create a device, having a long service life, that is inexpensive, has the least possible susceptibility to faults and is low-maintenance.

This object is achieved by the devices and methods defined in the independent claims. Further embodiments are disclosed by the dependent claims.

The invention relates to a device for applying fluids and for attaching as a tool to a robot arm. The device comprises a static element, a rotatable element and a coupling point. The coupling point connects the static element and the rotatable element to each other in a rotatable manner. The coupling point has, both on the static element side and on the rotatable element side, inductive coupling elements. The coupling elements are arranged in such a manner that inductive energy and/or signal transmission are/is rendered possible across the coupling point.

Fluid is to be understood to mean substances that have flow properties, such as, for example, liquids, gases, waxes and certain plastic compounds. Preferably, the fluid is a fluid that can be pumped at a pressure of from 20 to 250 bar and at a temperature of from 20° to 100° C., such as, for example, coating compounds or adhesives for automobile construction.

It is possible for the static element of the device to be such that it can be screw-connected, via one of its end faces, to the robot arm. It is conceivable that, in each case, an inductive coupling element of the static element and an inductive coupling element of the rotatable element can be rotated relative to each other about a common axis. The rotatable element can rotate by more than 360° relative to the static element. It is also possible for both the static element and the rotatable element to have an element, for example a power coil, that supplies energy. The transmission of energy in this case can be effected, from the static element to the rotatable element, via a common coupling point.

The inductive coupling elements of the coupling point allow energy and signals to be transmitted rapidly and without interference. It is possible for any number of signals to be transmitted. There is no need for cables that could limit the rotation capability of the rotatable element. In comparison with conventional sliding contacts, the service life of such inductive coupling units is increased considerably, and they are less maintenance-intensive, such that costs are reduced.

Preferably, the inductive coupling elements comprise flat coils, in particular having ferrite cores. The coupling point may comprises, for example, six such flat coils, wherein, respectively, three may be arranged in the rotatable element and three in the static element. Flat coils having ferrite cores are known to persons skilled in the art as means for inductively transmitting signals. Preferably, a flat coil of the static element and a flat coil of the rotatable element are located opposite each other, separated by a small gap, without electrical or physical contact. Typically, such a gap is a few millimeters, for example 2 mm. The flat coils may be let into the end faces of the respective elements on which the coupling point is located.

Flat coils having ferrite cores are characterized by their small space requirement and high performance capability. They are inexpensive, and are easily integrated into components. Moreover, already existing electrical coupling point of components, for example sliding contacts, can easily be replaced by such flat coils.

The static element may comprise signal and/or data processing electronics for converting digital signals to analog signals, and/or analog signals to digital signals. The rotatable element may comprise signal and/or data processing electronics for converting digital signals to analog signals and/or analog signals to digital signals.

For example, the signal and/or data processing electronics of the rotatable element and/or of the static element may comprise a microprocessor arranged on a printed circuit board. It is also conceivable that the signal and/or data processing electronics comprise a processor, a demodulator and/or modulator.

The integrated signal and/or data processing electronics enable signals and/or data to be transmitted rapidly and with precision. The data stream is reduced.

The signal and/or data processing electronics may be realized in the static element and the rotatable element and matched to each other so as to enable serial transmission of signals and/or data. It is also conceivable that parallel transmission of data is be possible between the static element and the rotatable element.

Serial transmission of data provides interference-free transmission, and minimizes the lines required for transmission of signals and data.

Preferably, it is made possible for signals to be transmitted bidirectionally between the static element and the rotatable element, in particular via respectively mutually corresponding coupling elements in the static element and rotatable element, for only one transmission direction in each case.

Bidirectional is to be understood to mean the transmission of signals and data, both from the static element to the rotatable element, and from the rotatable element to the static element. It is conceivable that a corresponding pair of coupling elements enables energy to be transmitted from the static element to the rotatable element. A further corresponding pair of coupling elements transmits signals and/or data from the static element to the rotatable element, and another pair of coupling elements transmits the signals and/or data in the other transmission direction. Preferably, three corresponding pairs of coupling elements can thus be arranged in the coupling point.

An advantage of the bidirectional transmission of data consists in that it becomes possible for the signals to be evaluated and processed already within the device, and the reaction times are shortened. This results in the device having a greater performance capability.

At least one inductive coupling element may be enclosed with a microprocessor in a common capsule. The capsule may be made, for example, from a plastic.

The microprocessor may be encapsulated on a printed circuit board and integrated into the capsule. The inductive coupling elements may also be constituent parts of modular assemblies. The capsules may be inserted or integrated into flat end faces of the rotatable and the static element that are opposite each other at the coupling point.

The enclosing of the inductive coupling elements in capsules has the advantage that the electrical coupling points are protected against dirt and corrosion. As a result, a significant improvement in production reliability is achieved, and the maintenance requirement is minimized.

An inverter, for converting direct voltage to alternating voltage that can be carried to an inductive coupling element, may be arranged in the static element. A rectifier, for converting alternating voltage to direct voltage that can be carried from an inductive coupling element, may be arranged in the rotatable element.

Such an arrangement has the advantage, on the one hand, that the direct voltage can be provided rapidly as an electrical supply to the rotatable element, and on the other hand it is possible for signals to be carried rapidly via the inductive coupling point.

Preferably, there is a modulator or demodulator assigned to at least one, preferably two, inductive coupling elements of the static element. Particularly preferably, there is a modulator assigned to an inductive coupling element of the static element, and a demodulator assigned to another inductive coupling element of the static element. Preferably, there is a modulator or demodulator assigned to at least one, preferably two, inductive coupling elements of the rotatable element. Particularly preferably, there is a modulator assigned to an inductive coupling element of the rotatable element, and a demodulator assigned to another inductive coupling element of the rotatable element.

A modulator of the static element can be used, for example, to condition a signal such that it can be transmitted to the rotatable element via the inductive coupling element. For example, signal conversion can be effected, from digital to analog. This signal can then be converted back to a digital signal in the demodulator. The modulator can be used to convert digital signals to alternating voltage signals that can be transmitted from the coupling element of the rotatable element to the coupling element of the static element. The demodulator of the coupling element of the static element can convert the alternating voltage signal back to digital signals. These signals can then be conditioned, for example in a processor of the static element, and provided in the serial data stream in a bus protocol of a higher-order process controller, e.g. programmable control unit.

Such transmission via a bus protocol has the advantage that all control signals and the corresponding check-back signals and measurement data can be carried via only one single cable having a small cross section.

This increases the mobility and maintainability of the applicator. Such an arrangement additionally has the advantage that the signals can be transmitted largely without interference. Moreover, simultaneous transmission of signals from the static element to the rotatable element and vice versa is possible.

At least two, preferably all, inductive coupling elements of the static element or of the rotatable element may be arranged concentrically.

Concentrically arranged coupling elements do not cause the transmission of signals to be restricted, even in the case of rotating motions of the rotatable element. The rotatable element may have at least one outlet valve having a valve needle. The outlet valve can preferably be controlled via a solenoid valve.

It is likewise conceivable that the device has two or more outlet valves. The solenoid valves in this case can regulate, for example, the compressed air that drives a pneumatic cylinder for controlling the needle valve. The corresponding control signals can be generated, for example, in the electronics in the static element. These control signals can be converted to analog signals with the aid of a modulator, and transmitted to the rotatable element via the inductive coupling elements. The demodulator in the rotatable element converts the analog signal back to digital signals for the outlet valves.

Preferably, the rotatable element has at least one sensor that senses the position of the valve needle(s). The sensor(s) may be arranged in such a manner that the position(s) can be transmitted to the signal and/or data processing electronics of the rotatable element.

It is likewise conceivable that the sensor(s) has/have integrated electronics that already effect the evaluation of the sensor signals.

For example, the sensors may be distance sensors. Typically, possibilities for this purpose are Hall sensors or inductive sensors. These may be digital or analog distance sensors. The current needle position may be effected, for example, by measurement of the distance of the needle position to the back wall of a pneumatic cylinder of the needle drive that is integrated in the device. The signal may then be transmitted to a processor, in particular a processor integrated in the rotatable element. By means of the processor it is possible to adaptively calibrate the measurement range of the distance sensors by the combination of control pulse and the measured needle position. The system can thus autonomously identify that the measured position is the expected end position of the valve needle, i.e. open or closed.

It is also possible that the sensor determines, not only the end position, but likewise one or more intermediate positions of the respective needle, and transmits this to the signal and/or data processing electronics of the rotatable element, or effects the processing in integrated electronics of the sensor.

The respective needle positions can thus be polled directly.

The sensing of the needle position enables the switching delay of the valve needle to be measured, and the switch-on points to be advanced accordingly. It is thus possible for process-related delays to be compensated automatically by means of the controller. The application accuracy is improved.

The static element is communicatively connectable or connected to a process controller.

The process controller may be a PC-based controller or a programmable control unit. It is likewise conceivable that the controller is the robot controller. The connection to the static element may be effected, for example, via a bus interface or an Ethernet connection. A wireless LAN connection would likewise be conceivable. The energy for operating the device can also be provided via the process controller, and this energy can be provided, via connection possibilities known to persons skilled in the art, to the static element for the purpose of conditioning.

The signal and/or data processing electronics of the rotatable element may be designed in such a manner that the position(s) of the valve needle(s) can be converted to a digital signal or digital signals, and/or the digital signal(s) can be converted to an analog alternating voltage signal or analog alternating voltage signals. The analog alternating voltage signal(s) can be supplied to an inductive coupling element and/or obtainable from the latter.

This has the advantage that rapid signal transmission can be effected via inductive coupling elements.

Preferably, arranged in the rotatable element of the device is a storage medium on which the switching intervals for opening and closing the valve needles are stored.

The storage medium may be, for example, a semiconductor memory, but data carriers that are not semiconductor memories are also conceivable.

The signal and data processing electronics of the static element and/or of the rotatable element may be designed in such a manner that they automatically calibrate the distance sensors for the purpose of polling the needle position, i.e. the electronics can identify which sensor signal corresponds to the desired end position (open/closed) of the needle position. The signal and data processing electronics can also be suitable for monitoring and measuring the internal reaction times of the applicator of the device. For example, the measurement values in this case may be already processed in the applicator and subsequently provided to the higher-order process controller. Thus, for example, the connected robot arm or a motion machine can automatically correct the switch-on and switch-off points, to enable a high-precision position of the fluid on the surface.

An applicator is understood to mean the unit composed of a rotatable element and a static element.

The rotatable element and/or the static element may comprise sensors for measuring the pressure; sensors for measuring the temperature; heating element(s), and combinations thereof.

The dosing mechanism that conveys the fluid to the outlet valve can be regulated by means of the pressure sensors. The temperature sensors can control, for example, the temperature of the applicator and/or the temperature of the fluid(s) supplied to the applicator. The heating element can serve to heat the applicator, but also other elements of the device. It is also conceivable that a heating element heats the fluid line and/or the outlet valve.

By means of the temperature sensors and heating elements, the viscosity of the fluid can be set so as to ensure improved conveyance of the fluid to the outlet valve. Conveyance can be optimized further by means of the pressure sensors. Moreover, a very good application result can also be achieved by means of the controllable pressure/flow of the fluid.

The device according to the invention enables the fluid to be applied under high pressures, of between 20 and 250 bar, preferably 100 to 250 bar. Nevertheless, high precision is still ensured in the application of the fluids. In the case of the application of paints, however, for example in the automobile industry, significantly lower pressures, of between 2 and 3 bar, are used.

Preferably, the rotatable element and the static element comprise at least one line, preferably a plurality of lines, for carrying compressed air and/or the fluid.

The lines may be designed in such a manner that there is an inlet channel, for supplying the fluid to a nozzle head, having at least one nozzle, in the rotatable element, and a return channel, for returning fluid from the nozzle head. The emission of the fluid is regulated via the pneumatically controlled valve needles.

The inlet channel and the return channel may be designed so as to enable circulation of the fluid. It is also conceivable for there to be an additional circulation valve, which controls the circulation, fitted in the lines. The rotation capability of the rotatable element is not limited by the lines. Preferably, the lines are designed as ring channels. The concentric coupling elements may be disposed close to these ring channels.

The advantage of this configuration is the unlimited free rotation capability of the rotatable parts.

The device according to the invention ensures precise and highly accurate application of the fluids, even at high pressures. Loss of material is minimized.

A further aspect of the invention relates to a method for transmitting energy and signals in a device for applying fluids, in particular a device as described in the present case. The method comprises the steps:
transmitting energy, for the purpose of supplying electric power, from a static element to a rotatable element of the device; and
transmitting signals from the static element to the rotatable element, and/or from the rotatable element to the static element,
   wherein the transmission of electric power and signals is effected via preferably concentrically arranged, inductive coupling elements of a coupling point of the device.

For the transmission of energy, an inverter may be mounted, for example in the static element, for converting direct voltage to alternating voltage, which, in a rectifier of the rotatable element, is converted back to direct voltage, following transmission via inductive coupling elements.

By means of a modulator of the static element, for example, a signal can be conditioned such that it can be transmitted to the rotatable element via the inductive coupling element. For example, signal conversion, from digital to analog, can be effected. In the demodulator of the rotatable element, this signal can then be converted back to a digital signal. By means of the modulator, digital signals can be converted to alternating-voltage signals that are transmitted from the coupling element of the rotatable element to the coupling element of the static element. The demodulator of the coupling element of the static element can convert the alternating-voltage signal back to digital signals. These signals can then be conditioned, for example in the electronics of the static element, and provided in the serial data stream in a bus protocol of a higher-order process controller, e.g. programmable control unit.

Owing to concentrically arranged inductive coupling elements, transmission of signals and/or data is effected without interference and with precision, even in the case of rotary motion of the rotatable element.

A further aspect of the invention relates to a method for switching at least one valve needle in a device for applying fluids, in particular as described in the present case. The method comprises the steps:
calibrating the end position of the valve needle(s),
determining the reaction time between a switching function command received at the device and the attainment of the end position of the valve needle(s) that corresponds to the switching function command,
optionally: storing the values for opening and/or closing the valve needle(s), in particular for a servicing interval,
optionally: defining a value range as a tolerance window or a limit value of the respective end position, for the purpose of monitoring wear, and
providing the reaction time of the process controller for the purpose of time coordination of the switching function commands.

In the case of calibration, a particular end position, e.g. open or closed, of the valve needle may be assigned, for example, to a particular sensor signal. Direct determination of the needle position is thereby possible. Preferably, for this purpose, each valve needle is actuated several times, and the respective value is stored. This value remains valid for the servicing interval. Wear, particular of the valves, causes a change in the value, and can thus be detected automatically.

The determination of the reaction time between the switching function command received at the device and the attainment of the end position of the valve needle that corresponds to the switching function command may be effected in the process controller. Alternatively, the reaction time may be determined in the processor of the device. The switching function command is usually provided from the higher-order process controller. When the device is put into operation for the first time, the reaction time between the switching function command received at the device and the attainment of the end position of the valve needle that corresponds to the switching function is determined for each valve needle. The values for the opening/closing of each of the valve needles can be stored for a servicing interval. However, the real values may change during the operating period as a result of wear. Definition of a value range as a tolerance window or a limit value of the respective end position enables the wear to be monitored. Thus, for example, values that deviate by a maximum of 10 percent may still be within the tolerance window. By contrast, values having a deviation of more than 10% lie outside the window, and would output a defined fault indication. Moreover, the reaction times in the process controller and/or processor may be provided as a value, such that they can be used for correcting the switching function commands. It is possible for old values to be overwritten with new values. It is also conceivable, however, to store older reaction times. Thus, in the case of each switching cycle, the time between the exiting of the one end position and the attainment of the other end position is measured. If this time exceeds a predefined time (e.g. 50 ms) a fault signal is output.

Such a method renders possible a type of self-diagnosis of the device, enabling the device to be serviced on the basis of need. As a result, maintenance costs are reduced considerably.

A further aspect of the invention relates to a method for converting electrical coupling points in a device for applying fluids, in particular a device as described in the present case. The method comprises the step:
replacing sliding contacts by inductive coupling elements.

This has the advantage that, in existing devices, the sliding contacts that are susceptible to faults can be replaced, inexpensively and without major structural alterations, by a contactless coupling point that has a low maintenance requirement and a long service life.

The invention also relates to the use of a coupling point having inductive coupling elements for the signal transmission of a needle position of a valve in a device for applying fluids.

The use of such a coupling point enables the needle position of the valve to be sensed in a precise and rapid manner. The sensing of the needle position, in combination with the switching function signals, enables the switching delay of the valve needle to be measured and evaluated, and the switch-on or switch-off points to be advanced accordingly. It is thus possible for process-related delays to be compensated automatically in the controller. The application accuracy is improved.

The invention is explained in greater detail in the following on the basis of the figures, which represent only exemplary embodiments. There are shown:

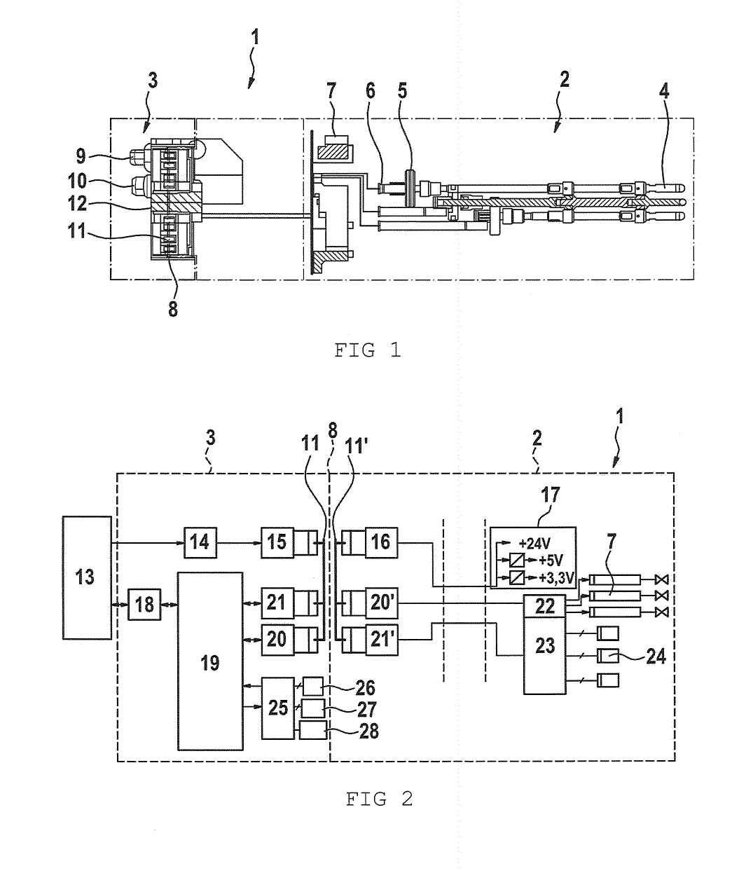

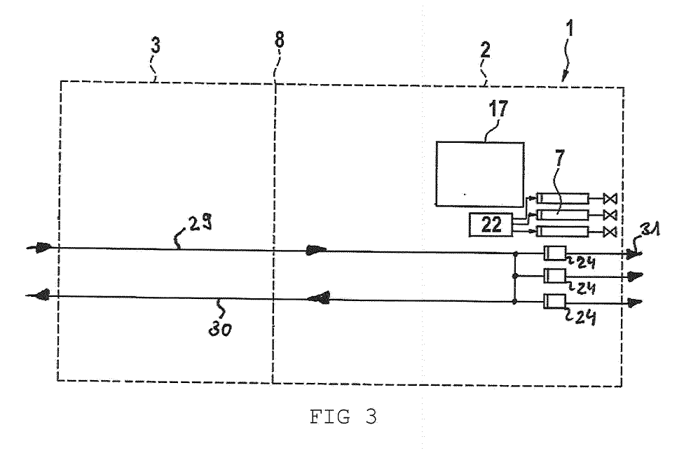

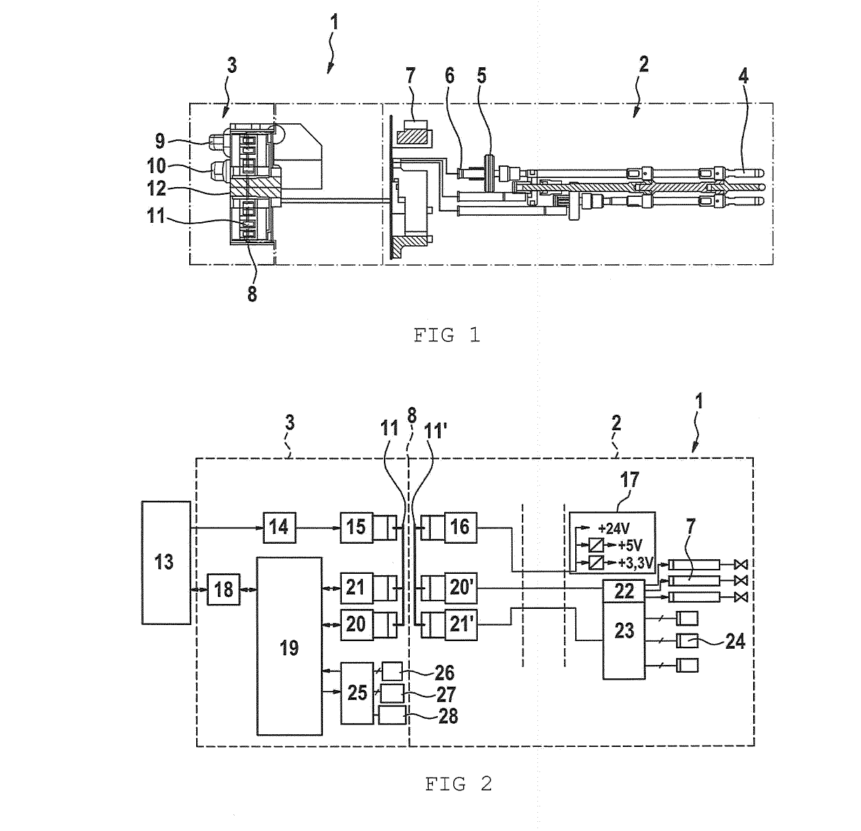

FIG. 1: schematic view of the device according to the invention

FIG. 2: circuit arrangement of the device according to FIG. 1

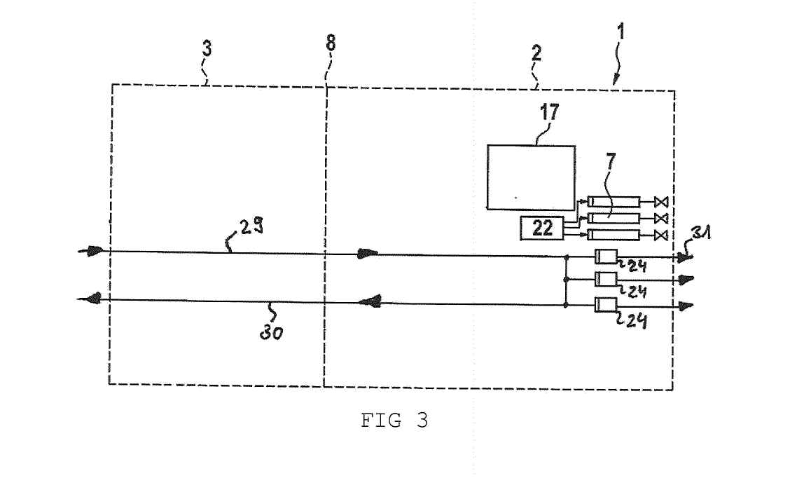

FIG. 3: course of the fluid of the device according to FIG. 2.

The device 1 represented in FIG. 1 is suitable for the application of fluids. The device 1 is composed substantially of a rotatable element 2 and a static element 3. The device 1 is suitable for attaching to a robot arm, wherein a connection can be effected via an end face 12 of the static element 3, for example by screwed connection. The static element 3 is disposed over a coupling point 8 to the rotatable element 2. The coupling point 8 has inductive coupling elements 11, both in the rotatable element 2 and in the static element 3. The inductive coupling elements 11 are flat coils having ferrite cores. The flat coils may be arranged in the elements in such a manner that, at most, a diameter of 84 mm and a structural height of 22 mm are required for integration of three flat coils. Typically, the inductive coupling elements are opposite each other, without contact, with a gap of 2 mm.

The static element 3 is supplied with energy via the connection 9. The static element 3 can be connected to a higher-order process controller (not shown) via a field bus connection 10. The rotatable element 2 can be supplied with energy via the inductive coupling elements 11. The rotatable element 2 has three needle valves 4 that are controlled by solenoid valves 7. A sensor 6 registers the position of the needle of the needle valves. The sensor 6 may be, for example, a sensor that may be composed of two Hall elements for generating four binary signals, or also an inductive sensor, by means of which the exact needle position is determined for the purpose of further processing in the data processing electronics.

FIG. 2 shows the circuit arrangement of the device 1 shown in FIG. 1, and individual elements of the rotatable element 2 and of the static element 3. A higher-order process controller 13 is connected to a power coil 14 of the static element 3 and thus supplies the static element 3 with energy. The direct-voltage signal for the supply of energy is converted, at the power coil 14 of the static element 3, by means of an inverter 15, to alternating voltage, and transmitted to an inductive coupling element 11 of the static element 3. Via the coupling point 8, the alternating-voltage signal for the supply of power is transmitted to the corresponding inductive coupling element 11′ of the rotatable element 2. The power coil 17 of the rotatable element 2 can then convert the alternating-voltage signal back to a direct-voltage signal, via a rectifier 16.

The higher-order process controller 13 also delivers the relevant data set for controlling the solenoid valves 7 and the heating 27. The data are transmitted to a bus interface 18.

The signals are provided to the modulator 20 via the processor 19 of the static element 3. The modulator 20 converts the digital control signals to analog signals. By means of a further inductive coupling element 11 of the static element 3, the analog signals are transmitted, via the coupling point 8, to the corresponding inductive coupling element 11′ of the rotatable element 2. The signal is converted in the demodulator 21′ of the rotatable element 2 and carried, for example via the processor 22/23, to the solenoid valves 7. The solenoid valves 7, for their part, control the supply of compressed air for a pneumatic cylinder (not shown), which in turn controls the position of the valve needles 24. The positions of the valve needles 24 are determined by means of sensors (FIG. 1, 6), and the signal can then be carried, via the processor 22/23, to a modulator 20′ of the rotatable element 2. In the modulator 20′ of the rotatable element 2, the signal is conditioned such that it can be transmitted, via an inductive coupling element 11′ of the rotatable element 2, to the inductive coupling element 11 of the static element 3. The signal is then converted back again in the demodulator 21 of the static element. The signal is processed in the processor 19 and carried, via the bus interface 18, to the higher-order process controller 13. The operating temperature can be set and controlled by means of additional temperature sensors 26. Via the process controller, pressure sensors 27 regulate the dosing mechanism by which the fluid is conveyed to the outlet valve. Furthermore, there may be additional heating elements 28 arranged in the static element 3, for heating, for example, the applicator (not shown) or for heating the fluid line. The corresponding signals may be processed via an analog adapter 25 and transmitted, on the one hand, to the processor 19 of the static element 3 and, on the other hand, obtain signals from the processor 19 for the purpose of regulation.

FIG. 3 shows the course of the fluid within the device. Elements from FIG. 2 that are not shown have been omitted for reasons of clarity.

Via an inlet channel 29, the fluid is supplied to a nozzle head, which has three nozzles that have controllable valve needles 24. The fluid is returned from the nozzle head via a return channel 30. The fluid can thus be circulated. The emission 31 of the fluid is regulated by means of the pneumatically controlled valve needles 24. The solenoid valves 7, for their part, control the supply of compressed air for a pneumatic cylinder (not shown), which, in turn, controls the position of the valve needles 24.

1-20. (canceled)

21. A device for applying fluids, for attaching as a tool to a robot arm, comprising:
a static element,
a rotatable element, and
a coupling point,
wherein said coupling point connects said static element and said rotatable element to each other in a rotatable manner, and said coupling point has inductive coupling elements, both on said static element side and on said rotatable element side, which are arranged in such a manner that inductive energy and/or signal transmission are/is rendered possible across said coupling point.

22. The device according to claim 21, wherein said inductive coupling elements comprise flat coils.

23. The device according to claim 21, wherein
said static element comprises signal and/or data processing electronics for converting digital signals to analog signals, and/or analog signals to digital signals;
said rotatable element comprises signal and/or data processing electronics for converting digital signals to analog signals and/or analog signals to digital signals.

24. The device according to claim 23, wherein said signal and/or data processing electronics is realized in said static element and said rotatable element and matched to each other so as to enable serial transmission of signals and/or data.

25. The device according to claim 21, wherein the device facilitates signals to be transmitted bidirectionally between said static element and said rotatable element.

26. The device according to claim 25, wherein said bidirectional transmission is made via respectively mutually corresponding coupling elements in said static element and said rotatable element for only one transmission direction in each case.

27. The device according to claim 21, wherein at least one inductive coupling element is enclosed with a microprocessor in a common capsule.

28. The device according to claim 21, wherein
an inverter, for converting direct voltage to alternating voltage that can be carried to an inductive coupling element, is arranged in said static element; and/or
a rectifier, for converting alternating voltage to direct voltage that can be carried from an inductive coupling element, is arranged in said rotatable element.

29. The device according to claim 21, wherein
a modulator or a demodulator is assigned to at least one inductive coupling elements of said static element; and/or
a modulator or a demodulator is assigned to at least one inductive coupling elements of said rotatable element;

30. The device according to claim 29, wherein the modulator is assigned to an inductive coupling element of said static element, and a demodulator is assigned to another inductive coupling element of said static element.

31. The device according to claim 29, wherein a modulator is assigned to an inductive coupling element of said rotatable element, and a demodulator is assigned to another inductive coupling element of said rotatable element.

32. The device according to claim 21, wherein at least two inductive coupling elements of said static element or of said rotatable element are arranged concentrically.

33. The device according to claim 21, wherein said rotatable element has at least one outlet valve having a valve needle.

34. The device according to claim 33, wherein said outlet valve is controlled via a solenoid valve.

35. The device according to claim 33, wherein said rotatable element has at least one sensor that senses the position of said valve needle(s) and is arranged, in such a manner, that the position(s) is transmitted to the signal and/or data processing electronics of said rotatable element.

36. The device according to claim 21, wherein said static element is communicatively connectable or connected to a process controller.

37. The device according to claim 33, wherein said signal and/or data processing electronics of said rotatable element is designed in such a manner that the position(s) of said valve needle(s) can be converted to a digital signal or digital signals, and/or the digital signal(s) can be converted to an analog alternating voltage signal or analog alternating voltage signals that can be supplied to an inductive coupling element and/or obtainable from the inductive coupling element.

38. The device according to claim 21, wherein a storage medium is arranged in said rotatable element on which switching intervals for opening and closing the valve needle(s) are stored.

39. The device according to claim 21, wherein said rotatable element and/or said static element comprise(s):
sensor(s) for measuring the pressure;
sensor(s) for measuring the temperature;
heating element(s), and
combinations thereof.

40. The device according to claim 21, wherein said rotatable element and said static element comprise at least one line for carrying compressed air and/or the fluid.

41. A method for transmitting energy and signals in a device for applying fluids comprising the steps:
transmitting energy, for the purpose of supplying electric power, from a static element to a rotatable element of the device (1); and
transmitting signals from said static element to said rotatable element, and/or from said rotatable element to said static element,
wherein the transmission of electric power and signals is effected inductive coupling elements of a coupling point of the device.

42. The method according to claim 41, further comprising arranging the inductive coupling elements concentrically.

43. A method for switching at least one valve needle in a device for applying fluids, comprising the steps:
calibrating an end position of a valve needle(s),
determining a reaction time between a switching function command received at the device and attainment of said end position of said valve needle(s) that corresponds to said switching function command,
optionally storing said values for opening and/or closing said valve needle(s),
optionally defining a value range as a tolerance window or a limit value of the respective end position, for the purpose of monitoring wear, and
providing said reaction time in a process controller for the purpose of time coordination of said switching function commands.

44. A method for converting electrical coupling points in a device for applying fluids, comprising the step:
replacing sliding contacts by inductive coupling elements.
